(19) United States
(12) Patent Application Publication
(10) Pub. No.: US 2025/0019562 A1
(43) Pub. Date: Jan. 16, 2025

(54) UV CURABLE WHITE COATING COMPOSITION AND ARTICLE

(71) Applicant: GUANDONG HUARUN PAINTS CO., LTD., Foshan City (CN)

(72) Inventor: Wei YANG, Foshan City (CN)

(21) Appl. No.: 18/709,932

(22) PCT Filed: Nov. 17, 2022
(86) PCT No.: PCT/CN2022/132653

§ 371 Date: May 14, 2024

(30) Foreign Application Priority Data
Nov. 19, 2021 (CN) 202111409089.3

(51) Int. Cl. C09D 151/08; C08K 3/22; C08K 5/5313; C09D 4/06; C09D 5/00; C09D 7/61

(52) U.S. Cl. CPC C09D 151/08; C08K 5/5313; C09D 4/06; C09D 5/00; C09D 7/61; C08K 2003/2217; C08K 2003/2241

(57) ABSTRACT

The present disclosure relates to a UV curable white coating composition comprising: (a) at least one (meth) acrylate polymer; (b) at least one reactive diluent; (c) titanium dioxide and magnesium oxide; and (d) at least one acylphosphine oxide; wherein relative to the total weight of the UV curable white coating composition, magnesium oxide is present in an amount of at least 10% by weight. The present disclosure further relates to an article comprising a coating formed by the white coating composition.

### BACKGROUND

The present disclosure claims priority from Chinese Patent Application No. 202111409089.3, filed on Nov. 19, 2021, which is incorporated herein by reference to its entirety.

### TECHNICAL FIELD

The present disclosure relates to a UV curable white coating composition, and further relates to an article comprising a coating formed by the white coating composition.

### BACKGROUND

Wood products include wood furniture, which are the most commonly used products in production and life, and are mainly made of wood substrates. As we all know, wood substrates have charm unmatched by other materials, such as special texture, natural color and so on. However, wood substrates inevitably have the characteristics of complex structure, uneven texture, being porous, water swelling and shrinkage, and undesired substances such as grease, tannin and other colored impurities, making them less than ideal industrial materials.

Therefore, the study of wood finishes that provide a protective layer for wood substrates is of particular interest. In recent years, white furniture has become popular with consumers in the market. Most white wood finishes are cured by using UV light sources. The existing UV-curable white wood finishes are difficult to reach higher values of whiteness according to ASTM E 313 (using the equation for Whiteness Index WI) due to the limitation of coating volume and other factors. The higher the value of WI, the greater is the indicated whiteness. For the perfect reflecting diffuser, WI=100

Therefore, there is still a need for UV-curable white coating compositions that can provide higher whiteness in the field of wood finishes.

### SUMMARY

The present disclosure provides a UV curable white coating composition comprising:
(a) at least one (meth)acrylate polymer;
(b) at least one reactive diluent;
(c) titanium dioxide and magnesium oxide; and
(d) at least one acylphosphine oxide;
   wherein relative to the total weight of the UV curable white coating composition, magnesium oxide is present in an amount of at least 10% by weight.

In some embodiments of the present disclosure, magnesium oxide is present in an amount of at most 50% by weight, relative to the total weight of the UV-curable white coating composition.

In some embodiments of the present disclosure, relative to the total weight of the UV-curable white coating composition, the sum of the amounts of titanium dioxide and magnesium oxide is from 40% to 65% by weight.

In another aspect, the present disclosure relates to a UV curable white coating composition, wherein relative to the total weight of the UV-curable white coating composition, the UV-curable white coating composition comprises:
(a) 15-30% by weight of the at least one (meth)acrylate polymer;
(b) 10-30% by weight of the at least one reactive diluent;
(c) 40-65% by weight of titanium dioxide and magnesium oxide;
(d) 1-5% by weight of a mixture of the at least one acylphosphine oxide; and
(e) 0.1-5% by weight of additional additives comprising dispersants, thickeners, defoamers, bactericides, or any combination thereof

In some embodiments of the present disclosure, L-value of the coating according to ASTM E 313 is at least 97.

In addition, the present disclosure further provides an article comprising a substrate partially or fully coated with the UV curable white coating composition according to the present disclosure.

Thus, the present disclosure further relates to use of magnesium oxide to increase the whiteness of a coating according to ASTM E 313 formed from the UV-curable white coating composition according to the present disclosure.

It has been surprisingly found that, adding magnesium oxide to a conventional UV curable white coating composition would significantly improve the whiteness of the cured coating, even better than a white coating composition using only titanium dioxide.

Titanium dioxide (TiO₂) is one of the most common white pigments used in coatings. However, in order to achieve a certain degree of whiteness, the coating must contain at least a significant amount of titanium dioxide, such that the pigment content is close to or even exceeds the maximum pigment content that can be allowed in the coating formulation. In contrast, the addition of magnesium oxide to UV curable white coating compositions, in combination with titanium dioxide commonly used in coating compositions, significantly improves the whiteness of the cured coating for the same pigment content, yielding whiteness (also referred to as L-value or Whiteness Index WI) according to ASTM E 313 of 97.3, or even 97.5 or more, which has never been recognized prior to the present disclosure.

The details of one or more embodiments of the disclosure are set forth in the following description. Other features, objects, and advantages of the disclosure will be apparent from the description and from the claims.

### Selected Definitions

As used herein, “a”, “an”, “the”, “at least one”, and “one or more” are used interchangeably, unless indicated otherwise. Thus, for example, a coating composition that comprises “an” additive can be interpreted to mean that the coating composition includes “one or more” additives.

Throughout the present disclosure, where compositions are described as having, including, or comprising specific components or fractions, or where processes are described as having, including, or comprising specific process steps, it is contemplated that the compositions or processes as disclosed herein may further comprise other components or fractions or steps, whether or not specifically mentioned in this disclosure, as long as such components or steps do not affect the basic and novel characteristics of what is described herein, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, ranges from any lower limit may be combined with any other lower limit to recite a range not explicitly recited, and in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, “acrylate” is a generic term for esters of acrylic acid and its homologues, such as methyl acrylate, ethyl acrylate, methyl 2-methacrylate, and ethyl 2-methacrylate. Accordingly, unless otherwise indicated, “acrylate” includes both acrylates and methacrylates.

When used in the context of a substrate, the term “major surface” is a surface defined by the lengthwise and widthwise dimensions of the substrate for providing the decoration.

As used herein, the term “topcoat” refers to a coating composition that can be applied to a primer and dried, crosslinked, or otherwise hardened to form a decorative or protective outermost finish coating. Further, such topcoats can withstand long-term outdoor exposure without showing visible and unsatisfactory deterioration.

The term “on” when used in the context of “ . . . applied on something” includes a paint or coating composition being applied directly or indirectly on another coating.

When appearing in this specification and claims, the terms “comprising” and “including” and variations thereof do not have a restrictive meaning.

In the present disclosure, a numerical range defined by an endpoint includes all any numerical value within that range, for example, a range of 1 to 5 encompasses numerical values of 1, 1.5, 2, 2.75, 3, 3.80, 4, 5, and the like. Also, the disclosed range of values includes all sub-ranges within that broader range, for example a range of 1 to 5 includes sub-ranges of 1 to 4, 1.5 to 4.5, 1 to 2, and the like.

The terms “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of what is described herein.

### DETAILED DESCRIPTION

In an aspect, the present disclosure provides a UV curable white coating composition comprising:
(a) at least one (meth)acrylate polymer;
(b) at least one reactive diluent;
(c) titanium dioxide and magnesium oxide; and
(d) at least one acylphosphine oxide;
   wherein relative to the total weight of the UV curable white coating composition, magnesium oxide is present in an amount of at least 10% by weight.

### (a) (Meth)Acrylate Polymer

In some embodiments of the present disclosure, the UV curable white coating composition comprises at least one (meth)acrylate polymer as a film-forming resin.

The at least one (meth)acrylate polymer comprises at least one of epoxy (meth)acrylate, polyurethane (meth)acrylate, polyester (meth)acrylate, polyether (meth)acrylate, and acrylate copolymer.

The epoxy (meth)acrylate polymer is an addition product of the reaction of epoxy resin and unsaturated carboxylic acid (for example, acrylic acid, methacrylic acid), including the epoxy (meth)acrylate of bisphenol A epoxy resin, epoxy (meth)acrylate or diglycidyl ether (meth)acrylate of phenol or cresol-novolac epoxy resin.

The polyurethane (meth)acrylate polymer is a reaction product prepared by reacting a hydroxyl-containing (meth)acrylate with a reaction product of a polyol and an organic polyisocyanate. The hydroxyl-containing (meth)acrylate is a hydroxyalkyl (meth)acrylate, such as 2-hydroxyethyl (meth)acrylate or 2-hydroxypropyl (meth)acrylate. The polyol includes ethylene glycol, propylene glycol or butylene glycol and the like. The organic polyisocyanate includes toluene diisocyanate, 4,4′-diphenylmethane diisocyanate, 4,4′-dicyclohexylmethane diisocyanate, hexamethylene diisocyanate or isophorone diisocyanate.

The polyester (meth)acrylate polymer is a dehydration condensation product of polyester polyol and (meth)acrylic acid. The polyester polyol is a reaction product of a polyol and a dibasic acid, wherein the polyol includes ethylene glycol, polypropylene glycol, 1,6-hexanediol, or trimethylolpropane, or combinations thereof, and the dibasic acid includes adipic acid, succinic acid, phthalic acid, hexahydrophthalic acid, terephthalic acid, or combinations thereof.

The polyether (meth)acrylate polymer is a polyalkyl glycol di(meth)acrylate, such as polyethylene glycol di(meth)acrylate or polypropylene glycol di(meth)acrylate.

The acrylate copolymer is a polymer obtained from the monomers such as (meth)acrylic acid, (meth)acrylate, styrene, or combinations thereof, under the action of a peroxide initiator (for example, benzoyl peroxide), by free radical polymerization.

Based on the total weight of the UV curable white coating composition, the (meth)acrylate polymer is present in an amount of 15 to 30% by weight, preferably in an amount 15 to 25% by weight.

### (b) Reactive Diluent

The reactive diluent comprises (meth)acrylic monomers. Monofunctional (meth)acrylic monomers include, for example, butanediol mono(meth)acrylate, cyclohexyl (meth)acrylate, dicyclopentanyl (meth)acrylate, dicyclopentenyl (meth)acrylate, dicyclopentenyloxyethyl (meth)acrylate, N,N-diethylaminoethyl (meth)acrylate, 2-ethoxyethyl (meth)acrylate, 2-hydroxyethyl (meth)acrylate, 2-hydroxypropyl (meth)acrylate, caprolactone-modified 2-hydroxyethyl (meth)acrylate, isobornyl (meth)acrylate, lauryl (meth)acrylate, acryloylmorpholine, N-vinylcaprolactam, nonylphenoxypolyethylene glycol (meth)acrylate, nonylphenoxypolypropylene glycol (meth)acrylate, phenoxyethyl (meth)acrylate, phenoxyhydroxypropyl (meth)acrylate, phenoxydiethylene glycol (meth)acrylate, polyethylene glycol (meth)acrylate, polypropylene glycol (meth)acrylate, tetrahydrofurfuryl (meth)acrylate and the like.

Polyfunctional (meth)acrylic monomers include, for example, 1,4-butanediol di(meth)acrylate, dicyclopentanyl di(meth)acrylate, ethylene glycol di(meth)acrylate, dipentaerythritol hexa(meth)acrylate, caprolactone-modified dipentaerythritol hexa(meth)acrylate, 1,6-hexanediol di(meth)acrylate, neopentyl glycol di(meth)acrylate, pentaerythritol tri(meth)acrylate, polyethylene glycol di(meth)acrylate, polypropylene glycol di(meth)acrylate, tripropyleneglycol di(meth)acrylate, tetraethylene glycol di(meth)acrylate, trimethylolpropane tri(meth)acrylate, tris(acryloxyethyl)isocyanurate, caprolactone-modified tris(acryloxyethyl)isocyanurate, tris(methacryloxyethyl)isocyanurate, tricyclodecane dimethanol di(meth)acrylate and the like.

These monofunctional (meth)acrylic monomers and polyfunctional (meth)acrylic monomers may be used solely or in combination with 2 or more monomers, or may be used in combination with the monofunctional and polyfunctional monomers.

As a component used in combination, monofunctional (meth)acrylate compounds may be preferably used for viscosity adjustment and/or physical property adjustment. In a certain application, alicyclic (meth)acrylate compounds such as isobornyl acrylate are preferable.

In a preferred embodiment according to the present disclosure, the reactive diluent is selected from at least one of dipropylene glycol di(meth)acrylate, tripropylene glycol di(meth)acrylate, dipentaerythritol hexa(meth)acrylate, dipentaerythritol penta(meth)acrylate, 1,6-hexanediol di(meth)acrylate, (ethoxylated) trimethylolpropane tri(meth)acrylate, (propoxylated) trimethylolpropane tri(meth)acrylate, pentaerythritol tri(meth)acrylate, pentaerythritol tetra(meth)acrylate and isobornyl (meth)acrylate.

Based on the total weight of the UV-LED curable white coating composition, the reactive diluent is present in an amount of 10 to 40% by weight, preferably in an amount of 10 to 30% by weight, and more preferably in an amount of 15 to 20% by weight.

### (c) Titanium Dioxide and Magnesium Oxide

Based on the total weight of the UV curable white coating composition, the magnesium oxide is present in an amount of at least 10 wt %, preferably in an amount of at least 20 wt %, and more preferably in an amount of at least 30 wt %. Based on the total weight of the UV curable white coating composition, the magnesium oxide is present in an amount of up to 50 wt %, preferably in an amount of up to 45 wt %, and more preferably in an amount of up to 40 wt %. Thus, based on the total weight of the UV curable white coating composition, the magnesium oxide is present in an amount of 10 wt % to 50 wt %.

Based on the total weight of the UV curable white coating composition, the titanium dioxide is present in an amount of at least 20 wt %, preferably in an amount of at least 25 wt %, more preferably in an amount of at least 30 wt %. Based on the total weight of the UV curable white coating composition, magnesium oxide is present in an amount of up to 45 wt %, preferably in an amount of up to 40 wt %, more preferably in an amount of up to 35 wt %, preferably in an amount of up to 30 wt %. Thus, the titanium dioxide is present in an amount of 20 wt % to 45 wt %, preferably 20 wt % to 40 wt %, based on the total weight of the UV curable white coating composition.

In a preferred embodiment according to the present disclosure, relative to the total weight of the UV-curable white coating composition, the sum of the amounts of titanium dioxide and magnesium oxide is from 40% to 65% by weight, preferably from 40 wt % to 60 wt %, and more preferably from 45 wt % to 55 wt %.

Titanium dioxide, is a white pigment commonly used in UV curable white coating compositions. However, in order to achieve a certain degree of whiteness, a coating must contain at least a significant amount of titanium dioxide, such that the pigment content approaches or even exceeds the maximum pigment content allowable in the coating formulation. In contrast, the present disclosure's pioneering addition of magnesium oxide to UV curable white coating compositions, in combination with titanium dioxide commonly used in coating compositions, significantly improves the whiteness of the cured coating for the same pigment content, even obtaining whiteness (also referred to as L-value or Whiteness Index WI) according to ASTM E 313 of 97.3, or even 97.5 or more, which has never been recognized before the present disclosure.

Without being bound to any theoretical limitations, it may be because the addition of magnesium oxide makes the magnesium oxide and titanium dioxide having different particle sizes effectively block the light transmission and enhance the overall coating coverage to achieve the effect of enhancing whiteness; in addition, the specific gravity of magnesium oxide is lighter than that of titanium dioxide, and during the film formation process, magnesium oxide migrates to the white top coat surface to enhance the overall whiteness. Therefore, less pigment is needed to achieve the same “covering” ability and higher whiteness value according to ASTM E 313.

Magnesium oxide is a commercially available product as a white powder with a particle size of D50 less than 100 nm.

### (d) Acylphosphine Oxide

In an embodiment according to the present disclosure, the UV curable white coating composition contains an acylphosphine oxide as a photoinitiator, which has significant absorption under LED light radiation with a wavelength in the range of 340-420 nm. As a typical split-type photoinitiator, the maximum absorption peak of acylphosphine oxide is in the range of 340-420 nm, which can effectively absorb UV light.

The acylphosphine oxide comprises a monoacylphosphine oxide, a bisacylphosphine oxide, or the combination thereof. The diacylphosphine oxide may be a compound of formula (I):

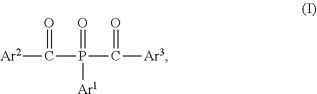

wherein each of Ar¹, Ar² and Ar³ is independently selected from a substituted or unsubstituted C6-C18 aryl group or a C1-C6 alkyl group.

The structure of the monoacylphosphine oxide is similar to that of the bisacylphosphine oxide, except that only one acyl group is directly linked to phosphorus. As an example, the monoacylphosphine oxide may be a compound of formula (II) (Lucirin TPO-L):

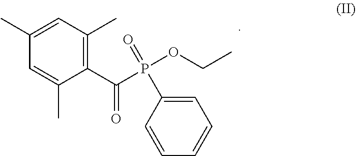 [SMILES: CCOP(=O)(C(=O)c1c(C)cc(C)cc1C)c1ccccc1]

Acylphosphine oxides suitable for use in the present disclosure include, but are not limited to, 2,4,6-trimethylbenzoyl diphenylphosphine oxide, 2,4,6-trimethylbenzoyl phenyl ethoxy phosphine oxide, bis(2,4,6-trimethylbenzoyl)-phenylphosphineoxide, or any combination thereof.

At present, both 2,4,6-trimethylbenzoyl diphenylphosphine oxide and bis(2,4,6-trimethylbenzoyl)-phenylphosphineoxide, are capable of absorbing UV light in the wavelength range of 385-410 nm.

Based on the total weight of the UV curable white coating composition, the acylphosphine oxide is present in an amount of 1% to 8% by weight, preferably in an amount of 1% to 5% by weight, and more preferably in an amount of 2% to 5% by weight.

In an embodiment of the present disclosure, the UV curable white coating composition further comprises an α-hydroxy photoinitiator, such as an α-hydroxy ketone photoinitiator. In the context of the present disclosure, “α-hydroxy ketone” refers to a class of organic compounds containing a hydroxyl group and a ketone group in the same molecule and the hydroxyl group is in the alpha position of the ketone group.

According to the present disclosure, α-hydroxy ketones include α-hydroxycyclohexyl phenyl ketone, 2-hydroxy-2-methyl-1-phenyl-1-propyl ketone, or any combination thereof.

It has been surprisingly discovered that the combination of α-hydroxy-type photoinitiators with acylphosphine oxides can achieve effective surface curing and deep curing when UV light is used as the radiation source for radiation curing.

In the present disclosure, the UV curable white coating composition may optionally further comprise conventional additives which do not adversely affect the coating composition or the cured coating obtained therefrom. Suitable additives include, for example, the agents that can improve the processability or manufacturing properties of the composition, enhance the aesthetics of the composition, or improve the specific functional properties or properties of the coating composition or the cured composition obtained therefrom (such as adhesion to the substrate). Examples of such additives are for example carriers, film forming auxiliaries, co-solvents, fillers, anti-migration aids, antibacterial agents, chain extenders, lubricants, wetting agents, biocides, plasticizers, antifoaming agent, wax, antioxidant, anticorrosive, flow control agent, thixotropic agent, dispersant, adhesion promoter, UV stabilizer, thickener, defoamer, pH adjuster, or combination thereof. The content of each optional ingredient is sufficient to achieve its intended purpose, but preferably such an amount does not adversely affect the coating composition or the cured coating obtained therefrom. In one preferred embodiment of the present disclosure, the suitable additive includes surfactants, dispersants, thickeners, defoamers, bactericides, or any combination thereof.

The amount of additional additives, relative to the total weight of the UV curable white coating composition, is in the range of from about 0 to about 10 wt %, preferably in the range of from about 0.1 to about 5 wt %, and more preferably in the range of from about 0.1 to about 1 wt %. In one embodiment of the present disclosure, the UV curable white coating composition comprises, relative to the total weight of the UV curable white coating composition, from 0.1 to about 10 wt % of additional additives. Specifically, the amount of additional additives contained in the UV curable white coating composition, relative to the total weight of the UV curable white coating composition, is from about 0.2 wt %, about 0.3 wt %, about 0.4 wt %, about 0.6 wt %, about 0.7 wt %, about 0.8 wt %, or about 0.9 wt % to about 9.0 wt %, about 7.0 wt %, about 6.0 wt %, about 5.0 wt %, about 4.0 wt %, about 2.0 wt %, or about 1.0 wt %.

In one embodiment of the present disclosure, relative to the total weight of the UV-curable white coating composition, the UV-curable white coating composition comprises:
(a) 15-30% by weight of the at least one (meth)acrylate polymer;
(b) 10-30% by weight of the at least one reactive diluent;
(c) 40-65% by weight of titanium dioxide and magnesium oxide;
(d) 1-5% by weight of a mixture of the at least one acylphosphine oxide; and
(e) 0.1-5% by weight of additional additives comprising at least one: dispersant, thickener, defoamer, bactericide, or any combination thereof.

Suitable dispersants may include anionic dispersants, cationic dispersants, nonionic dispersants, amphoteric dispersants, or any combination thereof. All types of dispersants are commercially available commodities.

In a preferred embodiment, the UV curable white coating composition, relative to the total weight of the UV curable white coating composition, may comprise from about 0.1 wt % to about 3 wt %, preferably from about 0.2 wt % to about 2 wt % of the dispersant. Specifically, the amount of dispersant contained in the UV curable white coating composition is in the range of from about 0.2 wt %, about 0.3 wt %, about 0.4 wt %, about 0.5 wt %, about 0.6 wt % to about 2.5 wt %, about 2.0 wt %, or about 1.5 wt %, relative to the total weight of the UV curable white coating composition.

Suitable thickeners include cellulose ether thickeners, alkali swelling thickeners, polyurethane thickeners, hydrophobically modified polyurethane thickeners, or any combination thereof. All types of thickeners are commercially available products. For example, a cellulose ether thickener like a methyl hydroxyethyl cellulose ether thickener can be used. As an example of an alkali swelling thickener, hydrophobically modified polyurethane thickener can be used. As a hydrophobic modified polyurethane thickener, a non-ionic urethane rheology modifier can be used.

In a preferred embodiment, the UV curable white coating composition, relative to the total weight of the UV curable white coating composition, may comprise from about 0.1 wt % to about 2 wt %, preferably from about 0.4 wt % to about 1.0 wt % of the thickener. Specifically, the amount of thickener contained in the UV curable white coating composition is in the range of from about 0.2 wt %, about 0.3 wt %, about 0.4 wt %, about 0.5 wt %, about 0.6 wt %, about 0.7 wt %, about 0.8 wt %, or about 0.9 wt % to about 2.0 wt %, about 1.5 wt %, or about 1.0 wt %, relative to the total weight of the UV curable white coating composition.

The leveling agent is an agent that can promote the film-forming resin to form a flat, smooth and uniform coating film during the film-forming process. Suitable leveling agents include silicone leveling agents, polyacrylic leveling agents, or any combination thereof. As an example of a commercially available leveling agent, a modified urea liquid rheology additive can be used.

Suitable defoamers include organosiloxane defoamers, grease defoamers, polyether defoamers, polyether modified silicone defoamers, or any combination thereof. All types of defoamers are commercially available products. As an example of an organosiloxane defoamer, a VOC-free silicone defoamer.

In one embodiment, the UV curable white coating composition comprises from about 0.1% by weight to about 1% by weight, preferably about 0.2% by weight to about 0.8% by weight of the defoamer, relative to the total weight of the UV curable white coating composition. Specifically, the amount of the defoamer contained in the UV curable white coating composition is, relative to the total weight of the UV curable white coating composition, from about 0.1% by weight, about 0.2% by weight, 0.3% by weight, about 0.4% by weight, about 0.5% by weight, or about 0.6% by weight to about 1.0% by weight, about 0.9% by weight, or about 0.8% by weight.

Suitable wetting agents may include but are not limited to silicone-based wetting agents, acetylene glycol-based wetting agents, or combinations thereof. All types of wetting agents are commercially available products. As an example of a silicone-based wetting agent, a solution of a polyether-modified polysiloxane can be used.

In a preferred embodiment, the UV curable white coating composition comprises from about 0.1% by weight to about 2% by weight, preferably about 0.4% by weight to about 1.0% by weight of the wetting agent, relative to the total weight of the UV curable white coating composition. Specifically, the amount of the wetting agent contained in the UV curable white coating composition is, relative to the total weight of the UV curable white coating composition, from about 0.2% by weight, about 0.3% by weight, about 0.4% by weight, about 0.5% by weight, about 0.6% by weight, about 0.7% by weight, about 0.8% by weight, or about 0.9% by weight to about 2.0% by weight, about 1.5% by weight, about 1.0% by weight.

In one embodiment, the UV curable white coating composition comprises from about 0.1% by weight to about 1% by weight, preferably about 0.2% by weight to about 0.8% by weight of the defoamer, relative to the total weight of the UV curable white coating composition. Specifically, the amount of the defoamer contained in the UV curable white coating composition is, relative to the total weight of the UV curable white coating composition, from about 0.1% by weight, about 0.2% by weight, 0.3% by weight, about 0.4% by weight, about 0.5% by weight, about 0.6% by weight, about 0.7% by weight, about 0.8% by weight, or about 0.9% by weight to about 2.0% by weight, about 1.5% by weight, or about 1.0% by weight.

The content of each optional component is sufficient to achieve its intended purpose, but preferably, such content does not adversely affect the UV curable white coating composition or the cured coating obtained therefrom. According to certain embodiments of the present disclosure, the total amount of additional additives is in the range of about 0% to about 20% by weight, preferably about 0.1% to about 5% by weight, relative to the total weight of the UV curable white coating composition.

The UV curable white coating composition according to the present disclosure is curable when irradiated with ultraviolet light.

In the present disclosure, the preparation of the UV curable white coating composition can be carried out by methods commonly used in the art.

According to the present disclosure, the UV curable white coating composition can be applied by conventional coating methods known to those skilled in the art. The coating methods include dip coating, spin coating, spray coating, curtain coating, brush coating, roll coating, and other coating methods known in the art.

The UV curable white coating composition according to the present disclosure is capable of undergoing photopolymerization when applied to the surface of a substrate and irradiated by UV light, thereby providing a cured coating on the surface of said substrate.

Due to the specific composition described above, the UV curable white coating composition according to the present disclosure is cured with high efficiency. The UV curable white coating composition according to the present disclosure provides good surface curing properties after curing. Compared to conventional UV curable white coating compositions, the UV curable white coating composition according to the present disclosure, after curing, yields a comparable, or even better, whiteness and yellowing resistant coating.

In the embodiment of the present disclosure, the coating formed by the UV curable white coating composition cured on a clearcoated white drawdown chart has an L-value (also referred to as Whiteness Index WI) of at least 97, preferably at least 97.3, more preferably at least 97.5, even more preferably at least 97.7, most preferably at least 98.

The color difference value ΔE of the coating formed by curing the UV curable white coating composition according to the present disclosure on a clearcoated white drawdown chart is less than 2.0, and Δb<1.5. The color difference value test is detailed in the example section.

Therefore, the UV curable white coating composition according to the present disclosure can used as a topcoat or primer, preferably as a topcoat.

Therefore, the present application further provides an article comprising a substrate partially or fully coated with the UV curable white coating composition according to the present disclosure. Those skilled in the art will select and determine a suitable material as the substrate according to actual needs.

The substrate may be a non-heat sensitive substrate such as glass, ceramic, fiber cement board or metal (e.g. aluminum, copper or steel), or may be a heat sensitive substrate.

Suitable heat sensitive substrates include wood substrates such as solid wood, for example: hard wood, soft wood, plywood; veneer, particle board, low density fibre board, medium density fibreboard and high density fibreboard, OSB (Oriented Strand Board) wood laminates, chipboard and other substrate in which wood is an important constituent, such as for example foil covered wooden substrates, engineered wood, plastic modified wood, plastic substrates or wood plastic compounds (WPC); substrates with cellulosic fibres, for example cardboard or paper substrates. Wood substrates may also include wood composites.

As the wood substrate used to manufacture the wood article of the present disclosure, any suitable wood substrate known in the art can be used. In the present disclosure, the term “wood substrate” refers to any cellulose/lignin material derived from the hard, fibrous structural organization of the stems and roots of trees or other woody plants. Wood includes, for example, hardwood and softwood wood cut directly from trees, and engineered wood composite materials made of wood strips, wood chips, wood fibers, or wood veneers. Examples of wood composite materials include, but are not limited to, plywood, oriented strand board (OSB), medium density fiberboard (MDF), particle board, and the like.

As exemplary wood substrates, hardwood, chestnut, eucalyptus, red chestnut, camellia, eucalyptus, Douglas fir, Japanese cedar, American cypress, Japanese red pine, Japanese cypress, water walnut, black walnut, maple, Japan beech, Japanese paulownia, birch, Borneo, magnolia, ash, teak, Xylosma japonicum, Catalpa wood, Dryobalanops spp., fir, oak and rubber wood.

According to the present disclosure, the wood substrate has at least one, preferably two major surfaces facing each other.

According to the present disclosure, the wood articles thus obtained can be used in the following applications, including, but not limited to: household furniture, such as tables, chairs, cabinets; bedroom and bathroom furniture; office furniture; custom furniture, such as school and children's furniture, hospitals furniture, restaurant and hotel furniture, kitchen cabinets and furniture; panels for interior design; indoor and outdoor windows and doors; indoor and outdoor window and door frames; outdoor and indoor wall panels and wooden floors.

It has been surprisingly discovered that the addition of magnesium oxide to a conventional UV curable white coating composition would significantly improve the whiteness of the cured coating according to ASTM E 313, even better than a white coating composition using only titanium dioxide.

Thus, the present disclosure also relates to the use of magnesium oxide in improving the whiteness of coatings formed by UV curable white coating compositions according to the present disclosure, wherein the L-value of the coating on a clearcoated white drawdown chart according to ASTM E 313 is at least 97.3, preferably at least 97.5, more preferably at least 97.7, most preferably at least 98.

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples are commercially available and used directly without further treatment.

### EXAMPLES

### Testing Methods

### Adhesion

An adhesion test was performed to assess whether the coating was adhered to the coated substrate. The adhesion test was performed according to ASTM D 3359-Test Method B. Adhesion is usually classified as 0-5B, with 5B being the best and 0 being the worst.

### Whiteness (Also Referred to as L-Value or Whiteness Index WI)

The whiteness was measured according to ASTM E 313. Specifically, a No. 7 bar coater was used to blade UV curable white coating on BYK white paper card, with a coating amount of 15-20 g/m², curing with UV light (gallium lamp), curing energy 700-1000 mJ/cm²; then X-rite color difference instrument (model CI-64) was used to test the whiteness value according to ASTM E 313.

### Characterization of Yellowing Resistance

The UV curable white coating composition was bladed on the BYK white coating film test cardboard, with a coating amount of 15-20 g/m²; then cured with UV light (gallium lamp), with a curing energy of 700-1000 mJ/cm². After curing, a color difference meter was used to test and calculate (according to the following formula) the color difference between the coated area and the original white cardboard.

$${{{{Δ E = [ ( Δ L \text{*)}}^{2} + ( Δ a \text{*)}}^{2} + ( Δ b \text{*)}}^{2} ]}^{1 / 2}$$

in which, ΔL=Lₛₐₘₚₗₑ−L_{standard} (lightness difference); Δa=aₛₐₘₚₗₑ−a_{standard} (red/green difference); Δb=bₛₐₘₚₗₑ−b_{standard} (yellow/blue difference).
ΔE represents the total color difference;
Large ΔL means white, and small ΔL means black;
Large Δa means reddish, small Δa means greenish;
Large Δb means yellowish, small ΔL means blueish.

### Solvent Resistance Test

A tolerance test of a solvent, such as methyl ethyl ketone or alcohol, was performed to assess the “curing” or cross-linking of the coating. This test was carried out as described in ASTM D 5402 93. After a certain number (usually 50) of double-rubs (i.e., one back- and forth motion), the integrity of the coating was determined. Solvent resistance was usually divided into grades of 0-5, where 5=coating is complete without scratches (best), 4=almost no coating scratches, 3=clear that the coating is scratched, 2=the gloss of the coating disappears due to scratches, 0=the coating is peeled off to reach the substrate (worst).

### Materials

The materials used are listed in Table 1 below.

TABLE 1
Materials and related information

| Type of Material | Chemical Description |
|---|---|
| Polyfunctional (meth)acrylic | Hexanediol diacrylate (HDDA) |
| monomers or Reactive Diluent | |
| Acylphosphine oxide | 2,4,6-Trimethylbenzoyl diphenyl- |
| | phosphine oxide (TPO) |
| Acylphosphine oxide | Ethyl 2,4,6-trimethylbenzoyl phenyl- |
| | phosphonate (TPO-L) |
| Acylphosphine oxides | Bis(2,4,6-trimethylbenzoyl)phenyl- |
| | phosphine oxide |
| α-hydroxy ketone | 2-Hydroxy-2-methyl-1-phenyl-1- |
| | propanone |
| Resin | Polyester acrylic resin |
| Polyfunctional (meth)acrylic | Tripropyleneglycol diacrylate |
| monomers or Reactive Diluent | (TPGDA) |
| Polyglycol polyester modified | Dispersant |
| polyalkylene imine | |
| Silicone-free modified polymer | Defoamer |

The components were mixed according to the amounts shown in Table 2 to obtain a UV curable white coating composition.

The resulting coating composition was applied as a topcoat to the original wood-colored cherry veneer MDF board (which was pre-rolled with a UV-specific white primer and polished with 400 mesh sandpaper) to form a 15-micron coating. The resulting coating was then UV cured. The UV lamp (gallium lamp) used for emitting light at 280-380 nm with a power of 4500-5000 mW/cm².

The performance of the cured coating was measured according to the methods listed in the test methods, and the results were shown in Table 2.

TABLE 2

| | Comparative | Example | Example | Example | Example |
|---|---|---|---|---|---|
| Material | Example 1 | 1 | 2 | 3 | 4 |
| HDDA | 9 | 9 | 9 | 8 | 10 |
| TPO | 1.5 | 1.5 | 1.5 | 1 | |
| TPO-L | | | | | 1.5 |
| Bis(2,4,6- | 0.7 | 0.7 | 0.7 | 0 | 0.7 |
| trimethylbenzoyl)phenylphosphine | | | | | |
| oxide | | | | | |
| 2-Hydroxy-2-methyl-1-phenyl-1- | 1 | 1 | 1 | 1 | 1 |
| propanone | | | | | |
| Polyester acrylic resin | 19.6 | 19.6 | 19.6 | 18 | 19.5 |
| TPGDA | 11 | 11 | 11 | 17 | 12 |
| Polyglycol polyester modified | 2 | 2 | 2 | 2 | 2 |
| polyalkylene imine | | | | | |
| Silicone-free modified polymer | 0.2 | 0.2 | 0.2 | | 0.3 |
| defoamer | | | | | |
| TiO₂ | 55 | 40 | 40 | 27 | 33 |
| MgO | | 11 | 15 | 27 | 20 |
| Other additives | | 4 | | | |
| Total | 100 | 100 | 100 | 100 | 100 |

Characterization of the cured coating: complete
curing, no nail scratches on the surface

| | | | | | |
|---|---|---|---|---|---|
| Whiteness | 96.74 | 97.74 | 98.08 | 97.57 | 97.61 |
| a-red/green | −1.8 | −1.42 | −1.64 | −1.2 | −1.41 |
| b- yellow/blue | 1.14 | 2.52 | 1.48 | 1.75 | 2.12 |

As can be seen from the above results, the UV curable white coating compositions according to the present disclosure had a higher whiteness according to ASTM E 313 and excellent resistance to yellowing compared to Comparative Example 1. The present disclosure pioneered the addition of magnesium oxide to UV curable white coating compositions in combination with titanium dioxide, which was commonly used in coating compositions, to significantly improve the whiteness of the cured coating with the same pigment content, obtaining a whiteness (also referred to as L-value or Whiteness Index WI) according to ASTM E 313 of 97.3 or even 97.5 or more, which had never been recognized before the present disclosure.

### EMBODIMENTS

Embodiment 1: A UV curable white coating composition comprising:
(a) at least one (meth)acrylate polymer;
(b) at least one reactive diluent;
(c) titanium dioxide and magnesium oxide; and
(d) at least one acylphosphine oxide;
   wherein relative to the total weight of the UV curable white coating composition, magnesium oxide is present in an amount of at least 10% by weight.

Embodiment 2. The UV-curable white coating composition of embodiment 1, wherein magnesium oxide is present in an amount of at most 50% by weight, relative to the total weight of the UV-curable white coating composition.

Embodiment 3. The UV-curable white coating composition according to any one of embodiments 1 to 2, wherein the (meth)acrylate polymer is selected from at least one of epoxy (meth)acrylate, polyurethane (meth)acrylate, polyester (meth)acrylate, polyether (meth)acrylate, and acrylate copolymer.

Embodiment 4. The UV-curable white coating composition according to any one of embodiments 1 to 3, wherein the reactive diluent is selected from at least one of dipropylene glycol di(meth)acrylate, tripropylene glycol di(meth)acrylate, dipentaerythritol hexa(meth)acrylate, dipentaerythritol penta(meth)acrylate, 1,6-hexanediol di(meth)acrylate, (ethoxylated) trimethylolpropane tri(meth)acrylate, (propoxylated) trimethylolpropane tri(meth)acrylate, pentaerythritol tri(meth)acrylate, pentaerythritol tetra(meth)acrylate and isobornyl (meth)acrylate.

Embodiment 5. The UV-curable white coating composition according to any one of embodiments 1 to 4, wherein the acylphosphine oxide comprises monoacylphosphine oxide, bisacylphosphine oxide or a combination thereof.

Embodiment 6. The UV-curable white coating composition according to any one of embodiments 1 to 5, wherein the acylphosphine oxide comprises 2,4,6-trimethylbenzoyl diphenyl phosphine oxide, ethyl (2,4,6-trimethylbenzoyl)phenyl phosphinate, bis(2,4,6-trimethylbenzoyl)-phenylphosphine oxide, or any combination thereof.

Embodiment 7. The UV-curable white coating composition according to any one of embodiments 1 to 6, wherein, relative to the total weight of the UV-curable white coating composition, the sum of the amounts of titanium dioxide and magnesium oxide is from 40% to 65% by weight.

Embodiment 8. The UV-curable white coating composition according to any one of embodiments 1 to 7, wherein, relative to the total weight of the UV-curable white coating composition, titanium dioxide is present in an amount ranging from 20% to 45% by weight

Embodiment 9. The UV-curable white coating composition according to any one of embodiments 1 to 8, wherein, relative to the total weight of the UV-curable white coating composition, the UV-curable white coating composition comprises:
(a) 15-30% by weight of the at least one (meth)acrylate polymer;
(b) 10-30% by weight of the at least one reactive diluent;
(c) 40-65% by weight of titanium dioxide and magnesium oxide;
(d) 1-5% by weight of a mixture of the at least one acylphosphine oxide; and
(e) 0.1-5% by weight of additional additives comprising at least one: dispersant, thickener, defoamer, bactericide, or any combination thereof.

Embodiment 10. The UV-curable white coating composition according to any one of embodiments 1 to 9, further comprising at least one α-hydroxy photoinitiator.

Embodiment 11. The UV-curable white coating composition according to any one of embodiments 1 to 10, which is used as a top coat or primer, preferably as a top coat.

Embodiment 12. The UV-curable white coating composition according to any one of embodiments 1 to 11, wherein L-value of the coating according to ASTM E 313 is at least 97.

Embodiment 13. An article comprising a substrate partially or fully coated with the UV curable white coating composition according to any one of embodiments 1 to 12.

Embodiment 14. The article of embodiment 13, wherein the substrate is wood or wood composite.

Embodiment 15. Use of magnesium oxide to increase the whiteness of a coating according to ASTM E 313 formed from the UV-curable white coating composition according to any one of embodiments 1 to 12.

Embodiment 16. The use according to embodiment 15, wherein the L-value of the coating according to ASTM E 313 is at least 97.3, preferably at least 97.5.

While what has been described with respect to a number of embodiments and examples, those skilled in the art, having benefit of this disclosure, will appreciate that other embodiments can be devised which do not depart from the scope and spirit of what is disclosed herein.

What is claimed is:

1. A UV curable white coating composition comprising:
(a) at least one (meth)acrylate polymer;
(b) at least one reactive diluent;
(c) titanium dioxide and magnesium oxide; and
(d) at least one acylphosphine oxide;
wherein relative to the total weight of the UV curable white coating composition, magnesium oxide is present in an amount of at least 10% by weight.

2. The UV-curable white coating composition of claim 1, wherein magnesium oxide is present in an amount of at most 50% by weight, relative to the total weight of the UV-curable white coating composition.

3. The UV-curable white coating composition according to claim 1, wherein the (meth)acrylate polymer is selected from at least one of epoxy (meth)acrylate, polyurethane (meth)acrylate, polyester (meth)acrylate, polyether (meth)acrylate, and acrylate copolymer.

4. The UV-curable white coating composition according to claim 1, wherein the reactive diluent is selected from at least one of dipropylene glycol di(meth)acrylate, tripropylene glycol di(meth)acrylate, dipentaerythritol hexa(meth)acrylate, dipentaerythritol penta(meth)acrylate, 1,6-hexanediol di(meth)acrylate, (ethoxylated) trimethylolpropane tri(meth)acrylate, (propoxylated) trimethylolpropane tri(meth)acrylate, pentaerythritol tri(meth)acrylate, pentaerythritol tetra(meth)acrylate and isobornyl (meth)acrylate.

5. The UV-curable white coating composition according to claim 1, wherein the acylphosphine oxide comprises monoacylphosphine oxide, bisacylphosphine oxide or a combination thereof.

6. The UV-curable white coating composition according to claim 1, wherein the acylphosphine oxide comprises 2,4,6-trimethylbenzoyl diphenyl phosphine oxide, ethyl (2,4,6-trimethylbenzoyl)phenyl phosphinate, bis(2,4,6-trimethylbenzoyl)-phenylphosphine oxide, or any combination thereof.

7. The UV-curable white coating composition according to claim 1, wherein, relative to the total weight of the UV-curable white coating composition, the sum of the amounts of titanium dioxide and magnesium oxide is from 40% to 65% by weight.

8. The UV-curable white coating composition according to claim 1, wherein, relative to the total weight of the UV-curable white coating composition, titanium dioxide is present in an amount ranging from 20% to 45% by weight

9. The UV-curable white coating composition according to claim 1, wherein, relative to the total weight of the UV-curable white coating composition, the UV-curable white coating composition comprises:
(a) 15-30% by weight of the at least one (meth)acrylate polymer;
(b) 10-30% by weight of the at least one reactive diluent;
(c) 40-65% by weight of titanium dioxide and magnesium oxide;
(d) 1-5% by weight of a mixture of the at least one acylphosphine oxide; and
(e) 0.1-5% by weight of additional additives comprising at least one: dispersant, thickener, defoamer, bactericide, or any combination thereof.

10. The UV-curable white coating composition according to claim 1, further comprising at least one α-hydroxy photoinitiator.

11. The UV-curable white coating composition according to claim 1, which is used as a top coat or primer, preferably as a top coat.

12. The UV-curable white coating composition according to claim 1, wherein L-value of the coating according to ASTM E 313 is at least 97.

13. An article comprising a substrate partially or fully coated with the UV curable white coating composition according to claim 1.

14. The article of claim 13, wherein the substrate is wood or wood composite.

15. Use of magnesium oxide to increase the whiteness of a coating according to ASTM E 313 formed from the UV-curable white coating composition according to claim 1.

16. The use according to claim 15, wherein the L-value of the coating according to ASTM E 313 is at least 97.3, preferably at least 97.5.
